(19) United States
(12) Patent Application Publication
(10) Pub. No.: US 2026/0310174 A1
(43) Pub. Date: Oct. 8, 2026

(54) CONTROL DEVICE FOR CONTROLLING MACHINE BY EXTENSION SOFTWARE

(71) Applicant: FANUC CORPORATION, Yamanashi (JP)

(72) Inventors: Riki Ishii, Yamanashi (JP); Takahiro Tanaka, Yamanashi (JP)

(21) Appl. No.: 19/479,871

(22) PCT Filed: May 26, 2023
(86) PCT No.: PCT/JP2023/019768

§ 371 Date: Oct. 29, 2025

(51) Int. Cl. G05B 19/4155

(52) U.S. Cl. CPC G05B 19/4155; G05B 2219/50391

(57) ABSTRACT

A control device including a pre-processing program storage unit that stores pre-processing programs to be executed before change processing for extension software for controlling an extension function of a machine; a pre-processing program execution unit that executes the pre-processing programs stored in the pre-processing program storage unit; and a change processing unit that executes change processing for the extension software after execution of the pre-processing programs by the pre-processing program execution unit. The extension software is configured to include pre-processing programs corresponding to the extension software.

### CROSS-REFERENCE TO RELATED APPLICATIONS

This application is a National Stage application of International Application No. PCT/JP2023/019768 filed May 26, 2023.

### BACKGROUND

### Field

The present disclosure relates to a controller controlling a machine with extended software.

### Discussion of the Related Art

A robot and a machine tool (hereinafter may be simply referred to as “machines”) are respectively controlled by a robot controller and a numerical controller (hereinafter may be simply referred to as “controllers”) in accordance with “standard software” and “extended software.” A standard operation of a machine is controlled by a controller of the machine in accordance with standard software already introduced (implemented) in the controller at the time of factory shipment of the machine and the controller. On the other hand, an optional function that can be added or removed afterwards and the operation of optional peripheral equipment are controlled by the controller in accordance with the extended software.

Robots and machine tools are highly flexible and are applicable to various uses, and an optional function and optional peripheral equipment can be further added to or removed from the controller as needed. For example, after factory shipment of a machine and a controller thereof, a user (a customer using the machine and the controller thereof) or a maker (a manufacturer of the machine and the controller thereof) may perform change processing, such as adding extended software to the controller or removing unnecessary extended software from the controller, according to the use and the purpose.

A technique enabling proper execution of change processing on extended software used for controlling an extensible function and peripheral equipment in a robot controller controlling a robot and a numerical controller controlling a machine tool is desired.

### SUMMARY

According to an aspect of the present disclosure, a controller includes an advance processing program storage unit configured to store an advance processing program executed before change processing on extended software for controlling an extension function of a machine, an advance processing program execution unit configured to execute the advance processing program stored in the advance processing program storage unit, and a change processing unit configured to execute the change processing on the extended software after execution of the advance processing program by the advance processing program execution unit, in which the extended software is configured to include the advance processing program related to the extended software.

### BRIEF DESCRIPTION OF DRAWINGS

FIG. 1 is a block diagram illustrating a controller according to an embodiment of the present disclosure.

FIG. 2 is a block diagram illustrating a controller according to a modified example of the embodiment of the present disclosure.

FIG. 3 is a flowchart illustrating an operation flow of addition processing in a first form of the controller according to the embodiment of the present disclosure and the modified example thereof.

FIG. 4 is a flowchart illustrating an operation flow of addition processing in a second form of the controller according to the embodiment of the present disclosure and the modified example thereof.

FIG. 5 is a flowchart illustrating an operation flow of addition processing in a third form of the controller according to the embodiment of the present disclosure and the modified example thereof.

FIG. 6 is a flowchart illustrating an operation flow of removal processing in the first form of the controller according to the embodiment of the present disclosure and the modified example thereof.

FIG. 7 is a flowchart illustrating an operation flow of removal processing in the second form of the controller according to the embodiment of the present disclosure and the modified example thereof.

FIG. 8 is a flowchart illustrating an operation flow of removal processing in the third form of the controller according to the embodiment of the present disclosure

### DESCRIPTION OF EMBODIMENTS

A controller controlling a machine with extended software according to an embodiment will be described below with reference to the drawings. It should be noted that components having the same or similar functions are given the same reference signs. Then, redundant description of the components may be omitted. For ease of understanding, the drawings use different scales as appropriate.

A controller according to an embodiment of the present disclosure is a robot controller controlling a robot or a numerical controller controlling a machine tool. While the case of the controller being a robot controller is described as an example, the following description is similarly applicable when the controller is a numerical controller.

### Overall Configuration of Embodiment of Present Disclosure

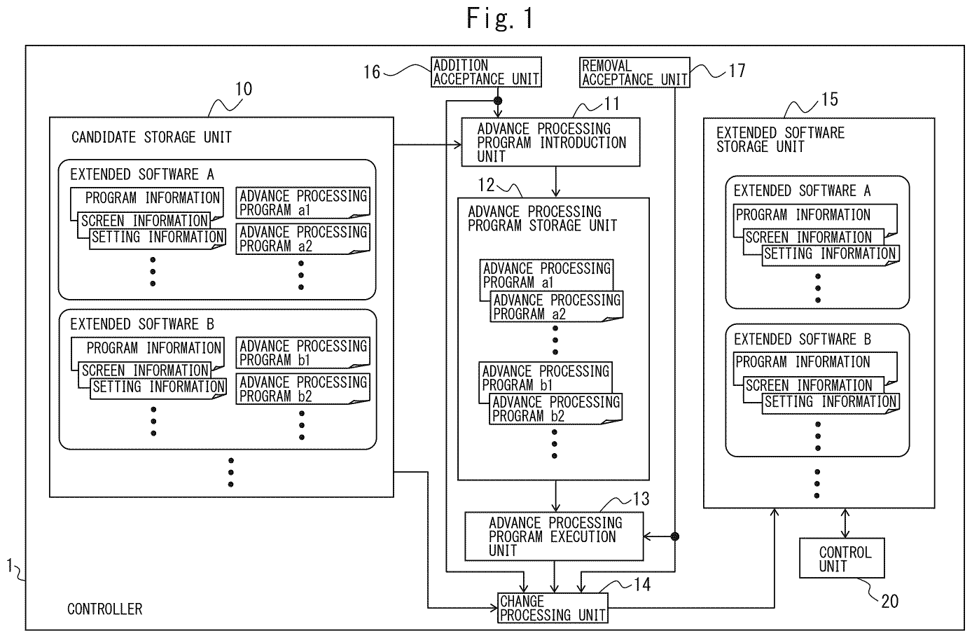

FIG. 1 is a block diagram illustrating a controller according to the embodiment of the present disclosure.

Functions of a controller 1 controlling a robot (unillustrated) can be roughly classified into standard functions and extension functions. The controller 1 according to the embodiment of the present disclosure controls the robot with standard software for controlling the standard functions of the controller 1 and extended software for controlling the extension functions of the controller 1.

The “standard functions” refer to a basic function previously installed (implemented) in the controller 1 and a function of controlling existing peripheral equipment. The controller 1 controls the standard functions of the controller 1 in accordance with the standard software.

The “extension functions” refer to a function of controlling an optional function that can be added to the controller 1 afterwards and a function of controlling optional peripheral equipment. The controller 1 controls the extension functions of the robot in accordance with the extended software. A change such as addition or removal can be made to the extension function of the controller 1 after the factory shipment of the robot and the controller 1. For example, when an extension function needs to be added to the controller 1 after the factory shipment of the robot and the controller 1, a user or a maker performs addition processing on extended software related to the extension function. When an extension function is no longer necessary in the controller 1 after the factory shipment of the robot and the controller 1, a user or a maker performs removal processing on extended software related to the extension function.

Examples of the extended software include extended software for controlling specific peripheral equipment of the robot, extended software for causing the arm of the robot to make a special movement, and extended software for causing the body (the base) of the robot to make a special movement but may also include other types of extended software. Among the aforementioned types of extended software, examples of the extended software for controlling specific peripheral equipment of the robot include extended software for controlling a specific hand attached to the robot, extended software for controlling a specific tool attached to the robot, extended software for controlling a specific camera attached to the robot, and extended software for controlling a specific sensor attached to the robot but may also include other types of extended software.

Extended software is defined for each extension function. In the embodiment of the present disclosure in particular, extended software is configured with an archive file including program information, screen information, setting information, and, additionally, an advance processing program as one package.

An advance processing program being a component of extended software is a program executed as advance processing for enabling smooth and proper “change processing on the extended software,” such as processing of adding the extended software to the controller 1 and removing the extended software from the controller 1,” in a preparatory stage before execution of the change processing on the extended software. In that sense, an advance processing program may also be referred to as a “preprocessing program”, a “preparatory processing program,” or the like.

Examples of an advance processing program include an advance processing program for changing the file name of program information, an advance processing program for defining an order in which pieces of extended software are added, an advance processing program for removing a main program defined in the program information, an advance processing program for halting execution of a main program defined in the program information, an advance processing program for halting the operation of peripheral equipment controlled by the extended software, an advance processing program for removing a main program operating with reference to program information of another piece of extended software, an advance processing program for defining an order in which pieces of extended software are removed, and an advance processing program for returning various variables of a main program defined in the program information to initial values but may include other advance processing programs.

Program information being a component of extended software defines a main program directly or indirectly involved in control of the extension function. For example, program information includes an instruction file describing an instruction to the controller 1 (processing to be executed for the extension function by the controller 1).

Screen information being a component of extended software includes a screen file and an image file that are used for screen display on a teaching operation panel (unillustrated) or an external display device (unillustrated) connected to the controller 1.

Setting information being a component of extended software defines information about various settings of the extension function controlled by the extended software. Examples of setting information include setting information about the supply voltage to peripheral equipment, setting information about communication with the peripheral equipment, setting information about a coordinate system of the robot, setting information about a load, and other setting information.

In the embodiment of the present disclosure, extended software in an archive file format including an advance processing program, program information, screen information, and setting information that are described above as one package is previously created. Then, when change processing (i.e., addition processing or removal processing) is performed on the extended software, an advance processing program is executed before execution of the change processing on the extended software, and the change processing is performed on the extended software after the execution of the advance processing program.

As illustrated in FIG. 1, the controller 1 according to the embodiment of the present disclosure includes a candidate storage unit 10, an advance processing program introduction unit 11, an advance processing program storage unit 12, an advance processing program execution unit 13, a change processing unit 14, an extended software storage unit 15, an addition acceptance unit 16, a removal acceptance unit 17, and a control unit 20. Further, while not being illustrated in the diagram, the controller 1 includes a power source, measurement equipment, input equipment, display equipment, cooling equipment, and other circuits.

The candidate storage unit 10 stores extended software being an addition candidate. Extended software stored in the candidate storage unit 10 is not directly used for control of the extension function by the controller 1 merely by being stored in the candidate storage unit 10. By previously storing, in the candidate storage unit 10, a plurality of pieces of extended software that may be added as addition candidates, a user purchasing the robot and the controller 1 thereof can easily and promptly select and add desired extended software. Storage of extended software being an addition candidate into the candidate storage unit 10 is performed by the maker of the controller 1 when the controller 1 is manufactured.

The candidate storage unit 10 does not need to be a storage device capable of high-speed read and write, and therefore a low-cost storage device with lower read and write speeds may be used. Further, the candidate storage unit 10 is preferably a high-capacity storage device in order to be able to store a plurality of pieces of extended software being addition candidates. Examples of the candidate storage unit 10 include a hard disk drive (HDD), a solid-state drive (SSD), and a flash memory. A greater number of pieces of extended software stored in the candidate storage unit 10 provides an advantage of widening the range of selections for extended software that can be added to the controller 1. In the example illustrated in FIG. 1, the candidate storage unit 10 stores extended software A, extended software B, and the like as an example.

The advance processing program storage unit 12 stores an advance processing program executed before change processing on extended software. The advance processing program storage unit 12 may be a nonvolatile memory such as an SRAM or an EEPROM, or a volatile memory such as a DRAM as long as the memory is rewritable.

The extended software storage unit 15 stores extended software added to the controller 1. Control of an extension function in the controller 1 is achieved by the control unit 20 executing extended software stored in the extended software storage unit 15. In other words, extended software stored in the extended software storage unit 15 is directly used for control of an extension function by the controller 1 instead of extended software stored in the candidate storage unit 10. The extended software storage unit 15 may be a nonvolatile memory such as an SRAM or an EEPROM, or a volatile memory such as a DRAM as long as the memory is rewritable.

The addition acceptance unit 16 accepts an addition command for selecting extended software to be added from among pieces of extended software being addition candidates stored in the candidate storage unit 10. For example, a list of pieces of extended software being addition candidates is displayed on a screen of an output device of the controller 1 or a teaching operation panel (unillustrated) connected to the controller 1, and an operator can refer to the list and perform an operation of selecting one or a plurality of pieces of extended software to be added by using an input device. In response to the operation by the operator, the input device sends an addition command indicating the selected extended software to be added to the addition acceptance unit 16. The addition acceptance unit 16 notifies the advance processing program introduction unit 11 and the change processing unit 14 of the acceptance of the addition command.

The removal acceptance unit 17 accepts a removal command for selecting extended software to be removed from among pieces of extended software stored in the extended software storage unit 15. For example, a list of pieces of extended software already added to the controller 1 is displayed on the screen of the output device of the controller 1 or the teaching operation panel (unillustrated) connected to the controller 1, and an operator can refer to the list and select one or a plurality of pieces of extended software to be removed by using the input device. In response to the operation by the operator, the input device sends a removal command indicating the selected extended software to be removed to the removal acceptance unit 17. The removal acceptance unit 17 notifies the advance processing program execution unit 13 and the change processing unit 14 of the acceptance of the removal command.

When the addition acceptance unit 16 accepts an addition command, the advance processing program introduction unit 11 reads an advance processing program in extended software to be added from the candidate storage unit 10 and stores the advance processing program into the advance processing program storage unit 12, before change processing being addition processing on extended software is executed. When the addition command accepted by the addition acceptance unit 16 indicates selection of a plurality of pieces of extended software to be added, the advance processing program introduction unit 11 reads all advance processing programs in the plurality of pieces of extended software to be added from the candidate storage unit 10 and stores the all advance processing programs into the advance processing program storage unit 12. In the example illustrated in FIG. 1, the advance processing program storage unit 12 stores advance processing programs a1, a2, and the like in the extended software A and advance processing programs b1, b2, and the like in the extended software B as an example.

When the addition acceptance unit 16 accepts an addition command, the advance processing program execution unit 13 executes an advance processing program related to extended software to be added out of advance processing programs stored in the advance processing program storage unit 12. When the removal acceptance unit 17 accepts a removal command, the advance processing program execution unit 13 executes an advance processing program related to extended software to be removed out of the advance processing programs stored in advance processing program storage unit 12. More specifically, the process is as follows.

When the addition acceptance unit 16 accepts an addition command, the advance processing program execution unit 13 executes an advance processing program related to extended software to be added out of the advance processing programs stored in the advance processing program storage unit 12, before addition processing on the extended software is executed by the change processing unit 14. When the addition command accepted by the addition acceptance unit 16 indicates selection of a plurality of pieces of extended software to be added, the advance processing program execution unit 13 executes at least one of all advance processing programs related to the pieces of extended software to be added out of the advance processing programs stored in the advance processing program storage unit 12.

When the removal acceptance unit 17 accepts a removal command, the advance processing program execution unit 13 executes an advance processing program related to extended software to be removed out of the advance processing programs stored in the advance processing program storage unit 12, before change processing being removal processing on extended software is executed by the change processing unit 14. When the removal command accepted by the removal acceptance unit 17 indicates selection of a plurality of pieces of extended software to be removed, the advance processing program execution unit 13 executes at least one of a plurality of advance processing programs related to the pieces of extended software to be removed out of the advance processing programs stored in the advance processing program storage unit 12.

The change processing unit 14 executes change processing on extended software after execution of an advance processing program by the advance processing program execution unit. More specifically, the process is as follows.

When the addition acceptance unit 16 accepts an addition command, the change processing unit 14 executes addition processing of reading extended software to be added from the candidate storage unit 10 and storing the software into the extended software storage unit 15, after the advance processing program execution unit 13 executes an advance processing program related to the extended software to be added. When the addition command accepted by the addition acceptance unit 16 indicates selection of a plurality of pieces of extended software to be added, the change processing unit 14 executes the addition processing after the advance processing program execution unit 13 executes at least one of all advance processing programs related to the pieces of extended software to be added. Consequently, the extended software to be added is added to the controller 1. In the example illustrated in FIG. 1, the extended software storage unit 15 stores pieces of the extended software A, B, and the like as an example.

When the removal acceptance unit 17 accepts a removal command, the change processing unit 14 executes processing of removing extended software to be removed from the extended software storage unit 15 as removal processing, after the advance processing program execution unit 13 executes an advance processing program related to the extended software to be removed. When the removal command accepted by the removal acceptance unit indicates selection of a plurality of pieces of extended software to be removed, the change processing unit 14 executes the removal processing after the advance processing program execution unit 13 executes at least one of all advance processing programs related to the pieces of extended software to be removed. Consequently, the extended software to be removed is removed from the controller 1.

It should be noted that while the advance processing program storage unit 12 and the extended software storage unit 15 are assumed to be separate storage devices, a storage area for the advance processing program storage unit 12 and a storage area for the extended software storage unit 15 may be provided separately in the same storage device. Consequently, further reduction in the mounting area on a substrate and further reduction in the manufacturing costs can be achieved.

At least one processor being an arithmetic processing unit is provided in the controller 1. Examples of the arithmetic processing unit include an IC, an LSI, a CPU, an MPU, and a DSP. The arithmetic processing unit includes the advance processing program introduction unit 11, the advance processing program execution unit 13, the change processing unit 14, the addition acceptance unit 16, the removal acceptance unit 17, the control unit 20, and other processing units. For example, each of the components included in the arithmetic processing unit is a function module provided by a program executed on the processor. For example, when the advance processing program introduction unit 11, the advance processing program execution unit 13, the change processing unit 14, the addition acceptance unit 16, the removal acceptance unit 17, the control unit 20, and the other processing units are constructed in a program format, the function of each unit can be provided by operating the arithmetic processing unit in accordance with the program. The program for executing processing in each of the advance processing program introduction unit 11, the advance processing program execution unit 13, the change processing unit 14, the addition acceptance unit 16, the removal acceptance unit 17, the control unit 20, and the other processing units may be provided in a form of being recorded on a computer-readable storage medium, such as a semiconductor memory, a magnetic storage medium, or an optical storage medium. Alternatively, the advance processing program introduction unit 11, the advance processing program execution unit 13, the change processing unit 14, the addition acceptance unit 16, the removal acceptance unit 17, the control unit 20, and the other processing units may be provided as a semiconductor integrated circuit in which the program providing the function of each unit is written.

Further, at least one memory being a storage device is provided in the controller 1. The memory includes the candidate storage unit 10, the advance processing program storage unit 12, and the extended software storage unit 15. Examples of the memory include electrically erasable-recordable nonvolatile memories, such as an EEPROM (registered trademark), and a random-access memory capable of high-speed read and write, such as a DRAM and an SRAM. Further, for example, the storage device may have a configuration such as a hard disk drive (HDD) or a solid state drive (SSD). The memory may store a program for operating the advance processing program introduction unit 11, the advance processing program execution unit 13, the change processing unit 14, the addition acceptance unit 16, the removal acceptance unit 17, the control unit 20, and the other processing units. Further, the memory may store various programs and various types of data that are related to the controller 1. Further, the memory may store various programs and various types of data that are related to the robot controlled by the controller 1.

### Overall Configuration of Modified Example of Embodiment of Present Disclosure

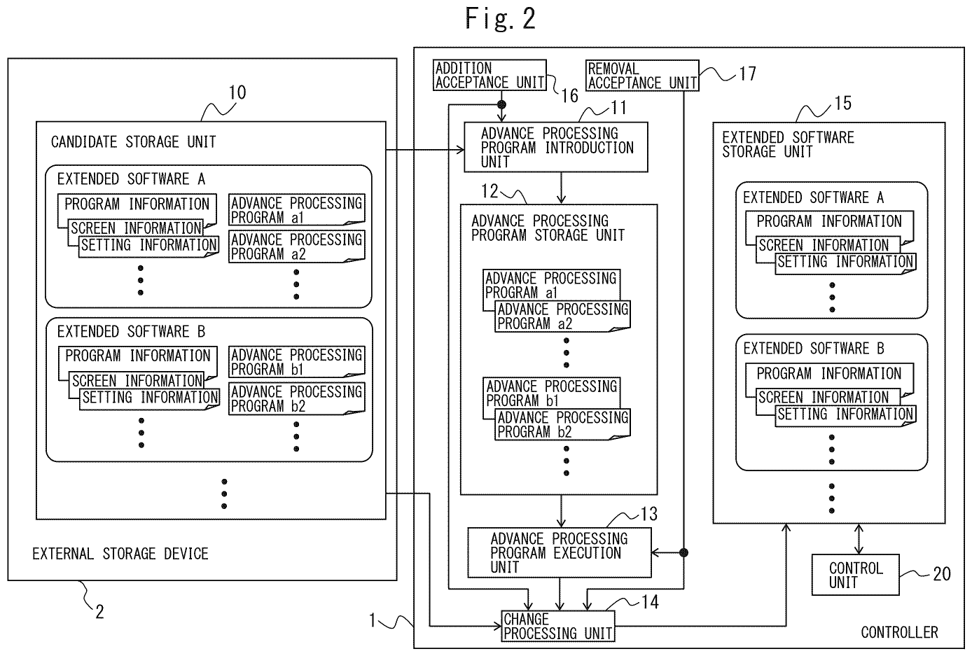

FIG. 2 is a block diagram illustrating a controller according to a modified example of the embodiment of the present disclosure.

While the candidate storage unit 10 is provided in the controller 1 in the embodiment described with reference to FIG. 1, the candidate storage unit 10 may be provided in an external storage device 2 external to the controller 1, as a modified example.

As illustrated in FIG. 2, the controller 1 according to the embodiment of the present disclosure includes an advance processing program introduction unit 11, an advance processing program storage unit 12, an advance processing program execution unit 13, a change processing unit 14, an extended software storage unit 15, an addition acceptance unit 16, a removal acceptance unit 17, and a control unit 20. While not being illustrated in the diagram, the controller 1 includes a power supply, measurement equipment, input equipment, display equipment, cooling equipment, and other circuits.

The advance processing program introduction unit 11, the advance processing program storage unit 12, the advance processing program execution unit 13, the change processing unit 14, the extended software storage unit 15, the addition acceptance unit 16, the removal acceptance unit 17, and the control unit 20 in the controller 1 are as described with reference to FIG. 1.

The external storage device 2 provided external to the controller 1 includes a candidate storage unit 10. The function and the operation of the candidate storage unit 10 are as described with reference to FIG. 1. When the addition acceptance unit 16 accepts an addition command, the advance processing program introduction unit 11 reads an advance processing program related to extended software to be added from the candidate storage unit 10 in the external storage device 2 and stores the program into the advance processing program storage unit 12, before addition processing is executed by the change processing unit 14. When the addition acceptance unit 16 accepts an addition command, the change processing unit 14 executes addition processing of reading extended software to be added from the candidate storage unit 10 in the external storage device 2 and storing the software into the extended software storage unit 15, after the advance processing program execution unit 13 executes the advance processing program.

Examples of the external storage device 2 include portable storage media such as a USB memory, an SD card, a micro SD card, a CD, a DVD, and an MO. The candidate storage unit 10 is connected to the advance processing program introduction unit 11 and the change processing unit 14 by electrically, magnetically, or optically connecting the external storage device 2 being a portable storage medium to the controller 1.

Further, for example, the external storage device 2 may be configured with a storage device connected to a network. In this case, the candidate storage unit 10 is connected to the advance processing program introduction unit 11 and the change processing unit 14 by connecting the external storage device 2 on the network and the controller 1 through wireless or wired communication. For example, the external storage device 2 on the network is provided in a factory, a warehouse, or an administration office where the controller 1 is installed, or a warehouse, a sales office, or a maintenance service center of the manufacturer of the controller 1 or the manufacturer of the robot.

Storage of extended software being an addition candidate into the candidate storage unit 10 is performed by the maker of the controller 1 when, for example, the external storage device 2 is manufactured. Further, for example, when the external storage device 2 is configured with a storage device connected to the network, the maker of the controller 1 may store extended software being an addition candidate into the candidate storage unit 10 in the external storage device 2 every time extended software is newly developed.

According to the modified example, newly developed extended software being an addition candidate can be readily provided to a user even after the shipment of the controller 1.

### Addition of Extended Software in Embodiment of Present Disclosure and Modified Example Thereof

Several operation flows for adding extended software to the controller 1 according to the embodiment of the present disclosure and the modified example thereof will be enumerated below.

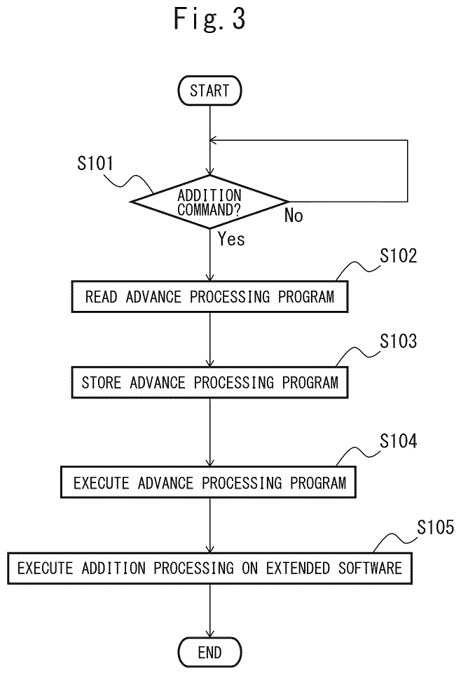

FIG. 3 is a flowchart illustrating an operation flow of addition processing in a first form of the controller 1 according to the embodiment of the present disclosure and the modified example thereof. In the addition processing in the first form, all advance processing programs related to one piece of extended software to be added are executed before the addition processing is executed on the extended software.

In step S101, the addition acceptance unit 16 determines whether an addition command is accepted.

When an addition command is determined to be accepted in step S101, the addition acceptance unit 16 notifies the advance processing program introduction unit 11 and the change processing unit 14 of the acceptance of the addition command. Then, in step S102, the advance processing program introduction unit 11 reads, from the candidate storage unit 10, an advance processing program in extended software to be added indicated in the addition command. When a plurality of advance processing programs are included in the extended software to be added, the advance processing program introduction unit 11 reads all advance processing programs from the candidate storage unit 10.

In step S103, the advance processing program introduction unit 11 stores the read advance processing program into the advance processing program storage unit 12. When a plurality of the read advance processing programs exist, the advance processing program introduction unit 11 stores the all programs into the advance processing program storage unit 12.

In step S104, the advance processing program execution unit 13 executes an advance processing program related to the extended software to be added out of the advance processing programs stored in the advance processing program storage unit 12. When a plurality of advance processing programs are stored in the advance processing program storage unit 12, the advance processing program execution unit 13 executes all advance processing programs related to the extended software to be added out of the advance processing programs stored in the advance processing program storage unit 12.

In step S105, the change processing unit 14 reads the extended software to be added indicated in the addition command from the candidate storage unit 10 and stores the software into the extended software storage unit 15.

In the addition processing in the first form described above, the processing in steps S101 to S105 is executed every time the addition acceptance unit 16 accepts an addition command.

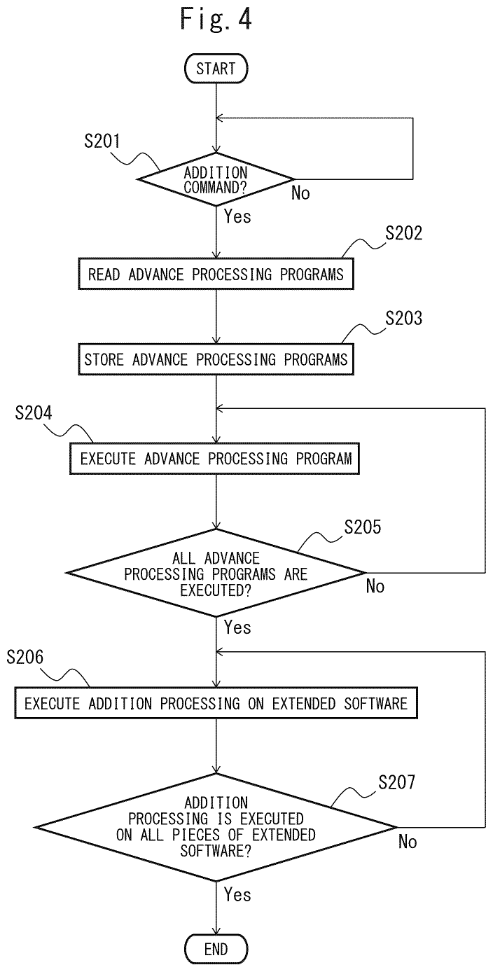

FIG. 4 is a flowchart illustrating an operation flow of addition processing in a second form of the controller 1 according to the embodiment of the present disclosure and the modified example thereof. In the addition processing in the second form, all advance processing programs related to extended software to be added are executed before the addition processing on a plurality of pieces of extended software is successively executed.

In step S201, the addition acceptance unit 16 determines whether an addition command for selecting a plurality of pieces of extended software to be added are accepted.

When an addition command for selecting a plurality of pieces of extended software to be added is determined to be accepted in step S201, the addition acceptance unit 16 notifies the advance processing program introduction unit 11 and the change processing unit 14 of the acceptance of the addition command for selecting a plurality of pieces of extended software to be added. Then, in step S202, the advance processing program introduction unit 11 reads all advance processing programs included in the plurality of pieces of extended software to be added from the candidate storage unit 10.

In step S203, the advance processing program introduction unit 11 stores all the read advance processing programs into the advance processing program storage unit 12.

In step S204, the advance processing program execution unit 13 executes an advance processing program related to extended software to be added out of the advance processing programs stored in the advance processing program storage unit 12.

In step S205, the advance processing program execution unit 13 determines whether all advance processing programs related to the extended software to be added are executed. When not all advance processing programs are determined to be executed in step S205, the processing returns to step S204. When all advance processing programs are determined to be executed in step S205, the processing proceeds to step S206. By repeated execution of steps S204 and S205, all advance processing programs stored in the advance processing program storage unit 12 are executed by the advance processing program execution unit 13.

In step S206, the change processing unit 14 reads the extended software to be added indicated in the addition command from the candidate storage unit 10 and stores the extended software into the extended software storage unit 15.

In step S207, the change processing unit 14 determines whether all pieces of extended software to be added are added. When not all pieces of extended software to be added are determined to be added in step S207, the processing returns to step S206. When all pieces of extended software to be added are determined to be added in step S207, the processing ends. By repeated execution of steps S206 and S207, all of a plurality of pieces of extended software to be added indicated in the addition command are stored in the extended software storage unit 15.

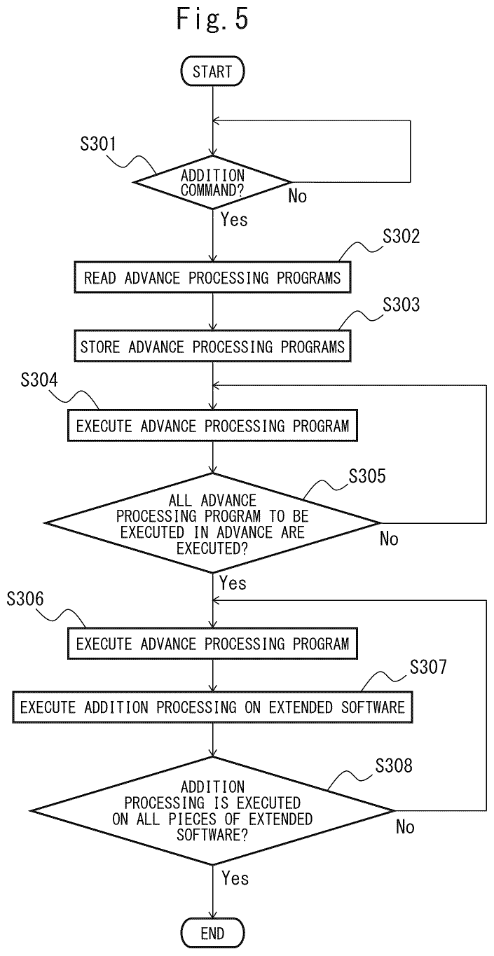

FIG. 5 is a flowchart illustrating an operation flow of addition processing in a third form of the controller 1 according to the embodiment of the present disclosure and the modified example thereof. When addition processing on a plurality of pieces of extended software is successively executed in the addition processing in the third form, part of a plurality of advance processing programs related to the pieces of extended software to be added are collectively executed, and the remaining advance processing programs are individually executed before the addition processing on each piece of extended software is executed. Advance processing programs to be collectively executed and advance processing programs to be individually executed may be previously defined when the controller 1 is manufactured or may be set as appropriate by an operator by using an input device.

In step S301, the addition acceptance unit 16 determines whether an addition command for selecting a plurality of pieces of extended software to be added is accepted.

When an addition command for selecting a plurality of pieces of extended software to be added is determined to be accepted in step S301, the addition acceptance unit 16 notifies the advance processing program introduction unit 11 and the change processing unit 14 of the acceptance of the addition command for selecting a plurality of pieces of extended software to be added. Then, in step S302, the advance processing program introduction unit 11 reads all advance processing programs included in the plurality of pieces of extended software to be added from the candidate storage unit 10.

In step S303, the advance processing program introduction unit 11 stores all the read advance processing programs into the advance processing program storage unit 12.

In step S304, the advance processing program execution unit 13 executes an advance processing program to be executed in advance, the program being related to extended software to be added, out of the advance processing programs stored in the advance processing program storage unit 12.

In step S305, the advance processing program execution unit 13 determines whether all advance processing programs to be executed in advance, the programs being related to the extended software to be added, are executed. When not all advance processing programs to be executed in advance are determined to be executed in step S205, the processing returns to step S304. When all advance processing programs to be executed in advance are determined to be executed in step S305, the processing proceeds to step S306. By repeated execution of steps S304 and S305, all advance processing programs to be executed in advance, the programs being stored in the advance processing program storage unit 12, are collectively executed by the advance processing program execution unit 13.

In step S306, the advance processing program execution unit 13 executes an advance processing program to be individually executed, the program being related to the extended software to be added, out of the advance processing programs stored in the advance processing program storage unit 12. It should be noted that the advance processing program executed in step S306 is related to extended software to be added in step S307 succeeding step S306.

In step S307, the change processing unit 14 reads the extended software to be added indicated in the addition command from the candidate storage unit 10 and stores the software into the extended software storage unit 15.

In step S308, the change processing unit 14 determines whether all pieces of extended software to be added are added. When not all pieces of extended software to be added are determined to be added in step S308, the processing returns to step S306. When all pieces of extended software to be added are determined to be added in step S308, the processing ends. By repeated execution of steps S306 to S308, all of the plurality of pieces of extended software to be added indicated in the addition command are stored in the extended software storage unit 15 while the advance processing programs to be individually executed are being executed.

As described above, in the first to third forms of the addition processing, the advance processing program execution unit 13 executes at least one of all advance processing programs stored in the advance processing program storage unit 12. Then, the change processing unit 14 executes the addition processing of storing extended software into the extended software storage unit 15 after the advance processing program execution unit 13 executes at least one of all the advance processing programs.

### Removal of Extended Software in Embodiment of Present Disclosure and Modified Example Thereof

Several operation flows for removing extended software from the controller 1 according to the embodiment of the present disclosure and the modified example thereof will be enumerated below.

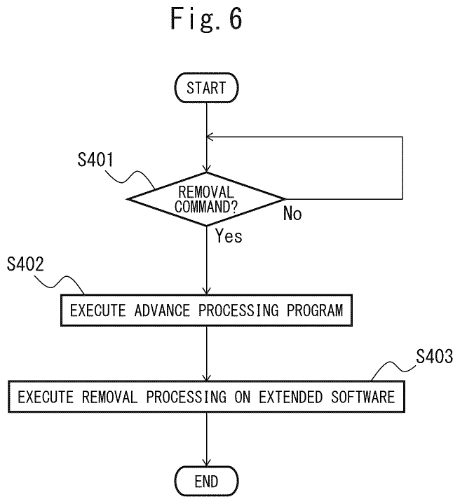

FIG. 6 is a flowchart illustrating an operation flow of removal processing in the first form of the controller 1 according to the embodiment of the present disclosure and the modified example thereof. In the removal processing in the first form, all advance processing programs related to extended software to be removed are executed before the removal processing on one piece of extended software is executed.

In step S401, the removal acceptance unit 17 determines whether a removal command is accepted.

When a removal command is determined to be accepted in step S401, the removal acceptance unit 17 notifies the advance processing program execution unit 13 and the change processing unit 14 of the acceptance of the removal command. Then, in step S402, the advance processing program execution unit 13 executes an advance processing program related to extended software to be removed out of advance processing programs stored in the advance processing program storage unit 12.

In step S403, the change processing unit 14 executes processing of removing the extended software to be removed from the extended software storage unit 15.

In the removal processing in the first form described above, the processing in steps S401 to S403 is executed every time the removal acceptance unit 17 accepts a removal command.

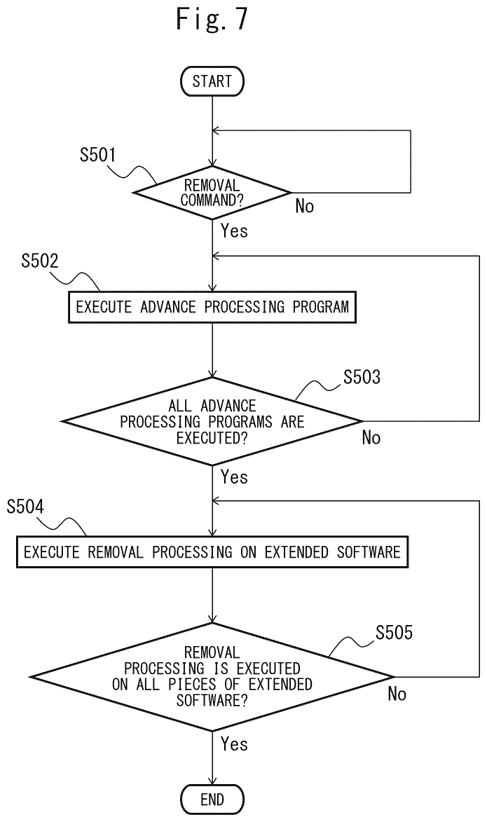

FIG. 7 is a flowchart illustrating an operation flow of removal processing in the second form of the controller 1 according to the embodiment of the present disclosure and the modified example thereof. In the removal processing in the second form, all advance processing programs related to extended software to be removed are executed before the removal processing on a plurality of pieces of extended software is successively executed.

In step S501, the removal acceptance unit 17 determines whether a removal command for selecting a plurality of pieces of extended software to be removed is accepted.

When a removal command for selecting a plurality of extended software to be removed is determined to be accepted in step S501, the removal acceptance unit 17 notifies the advance processing program execution unit 13 and the change processing unit 14 of the acceptance of the removal command for selecting a plurality of pieces of extended software to be added. Then, in step S502, the advance processing program execution unit 13 executes an advance processing program related to extended software to be removed out of advance processing programs stored in the advance processing program storage unit 12.

In step S503, the advance processing program execution unit 13 determines whether all advance processing programs related to the extended software to be removed are executed. When not all advance processing programs are determined to be executed in step S503, the processing returns to step S502. When all advance processing programs are determined to be executed in step S503, the processing proceeds to step S504. By repeated execution of steps S502 and S503, all advance processing programs stored in the advance processing program storage unit 12 are executed by the advance processing program execution unit 13.

In step S504, the change processing unit 14 executes processing of removing the extended software to be removed from the extended software storage unit 15.

In step S505, the change processing unit 14 determines whether all pieces of extended software to be removed are removed. When not all pieces of extended software to be removed are determined to be removed in step S505, the processing returns to step S504. When all pieces of extended software to be removed are determined to be removed in step S505, the processing ends. By repeated execution of steps S504 and S505, all of a plurality of pieces of extended software to be removed indicated in the removal command are removed from the extended software storage unit 15.

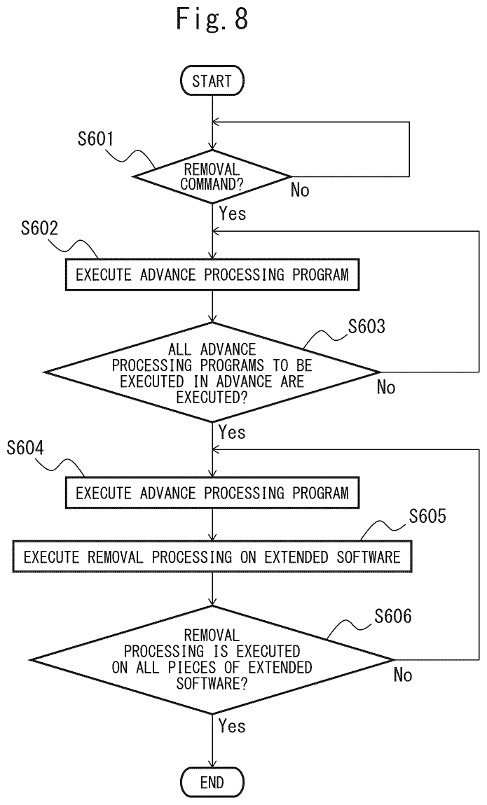

FIG. 8 is a flowchart illustrating an operation flow of removal processing in the third form of the controller 1 according to the embodiment of the present disclosure and the modified example thereof. When removal processing on a plurality of pieces of extended software is successively executed in the removal processing in the third form, part of a plurality of advance processing programs related to extended software to be removed are collectively executed, and the remaining advance processing programs are individually executed before the addition processing on each piece of extended software is executed. Advance processing programs to be collectively executed and advance processing programs to be individually executed may be previously defined when the controller 1 is manufactured or may be set as appropriate by an operator by using an input device.

In step S601, the removal acceptance unit 17 determines whether an addition command for selecting a plurality of pieces of extended software to be removed is accepted.

When a removal command for selecting a plurality of pieces of extended software to be removed is determined to be accepted in step S601, the removal acceptance unit 17 notifies the advance processing program execution unit 13 and the change processing unit 14 of the acceptance of the removal command for selecting a plurality of pieces of extended software to be removed. Then, in step S602, an advance processing program to be executed in advance, the program being related to extended software to be removed out of advance processing programs stored in the advance processing program storage unit 12, is executed.

In step S603, the advance processing program execution unit 13 determines whether all advance processing programs to be executed in advance, the programs being related to the extended software to be removed, are executed. When not all advance processing programs to be executed in advance are determined be executed in step S603, the processing returns to step S602. When all advance processing programs to be executed in advance are determined to be executed in step S603, the processing proceeds to step S604. By repeated execution of steps S602 and S603, all advance processing programs to be executed in advance, the programs being related to the extended software to be removed stored in the advance processing program storage unit 12, are collectively executed by the advance processing program execution unit 13.

In step S604, the advance processing program execution unit 13 executes an advance processing program to be individually executed, the program being related to the extended software to be removed, out of the advance processing programs stored in the advance processing program storage unit 12. It should be noted that the advance processing program executed in step S604 is related to the extended software to be removed in step S605 succeeding step S604.

In step S605, the change processing unit 14 executes processing of removing the extended software to be removed from the extended software storage unit 15.

In step S606, the change processing unit 14 determines whether all pieces of extended software to be removed are removed. When not all pieces of extended software to be removed are determined to be removed in step S606, the processing returns to step S604. When all pieces of extended software to be removed are determined to be removed in step S606, the processing ends. By repeated execution of steps S604 to S606, all of a plurality of pieces of extended software to be removed indicated in the removal command are removed from the extended software storage unit 15 while the advance processing programs to be individually executed While the case of the controller 1 being a robot controller controlling a robot has been described above, the aforementioned description is similarly applicable to a numerical controller controlling a machine tool.

As described above, according to the embodiment of the present disclosure, change processing, such as addition processing and removal processing, on extended software used for controlling an extensible function and peripheral equipment can be properly executed in a robot controller controlling a robot, a numerical controller controlling a machine tool, and the like.

For example, conventionally, addition of extended software to a controller fails when the extended software includes a program with the same name as a program existing in the controller. In preparation for such a situation, for example, extended software is preconfigured to include an advance processing program for changing the file name of program information, in the embodiment of the present disclosure and the modified example thereof. Then, when extended software is added to the controller, first, an advance processing program for changing the file name of the program information is executed, and then, addition processing on the extended software is executed. Consequently, addition of the extended software can be properly performed. Alternatively, for example, extended software is preconfigured to include an advance processing program for removing a main program operating with reference to program information of another piece of extended software. Then, when extended software is added to the controller, first, the advance processing program for removing a main program operating with reference to program information of another piece of extended software is executed, and then, the addition processing of the extended software is executed; and therefore, addition of the extended software can be properly performed.

For example, some extended software assumes that another piece of extended software is already added. When a plurality of pieces of extended software are added, the pieces of extended software need to be added in an appropriate order; and conventionally, a plurality of pieces of extended software may not be collectively added. In preparation for such a situation, for example, extended software is preconfigured to include an advance processing program for defining an order in which pieces of extended software are added, in the embodiment of the present disclosure and the modified example thereof. Then, when a plurality of pieces of extended software are added to the controller, first, the advance processing program for defining an order in which pieces of extended software are added is executed, and then, the addition processing on the pieces of extended software is executed in the order defined in the advance processing program. Consequently, addition of the pieces of extended software based on an appropriate order can be properly performed, and the plurality of pieces of extended software can be collectively added.

For example, when extended software is removed from the controller, all programs included in the extended software need to be set in a halted state. Conventionally, an attempt to remove extended software while a program included in the extended software is in execution causes a failure in the removal of the extended software. In preparation for such a situation, for example, extended software is preconfigured to include an advance processing program for halting execution of a main program defined in program information of the extended software, in the embodiment of the present disclosure and the modified example thereof. Then, when extended software is removed from the controller, first, a main program defined in the program information is halted by executing the advance processing program for halting execution of the main program, and then, the removal processing on the extended software is executed. Consequently, removal of the extended software can be properly performed.

For example, when extended software is removed from the controller, peripheral equipment controlled by the extended software needs to be halted. Conventionally, an attempt to remove extended software while peripheral equipment controlled by the extended software is in operation may cause a failure in removal of the extended software or a malfunction of the peripheral equipment. In preparation for such a situation, for example, extended software is preconfigured to include an advance processing program for halting the operation of peripheral equipment controlled by the extended software, in the embodiment of the present disclosure and the modified example thereof. Then, when the extended software is removed from the controller, first, the peripheral equipment is properly halted by executing the advance processing program for halting the operation of the peripheral equipment controlled by the extended software, and then, the removal processing on the extended software is executed. Consequently, removal of the extended software can be properly performed.

For example, when program information of extended software is referred to by another piece of extended software, the extended software cannot be removed first. Therefore, when removing a plurality of pieces of extended software, the pieces of extended software need to be removed in an appropriate order; and conventionally, the plurality of pieces of extended software may not be collectively removed. In preparation for such a situation, for example, extended software is preconfigured to include an advance processing program for removing a main program operating with reference to program information of another piece of extended software, in the embodiment of the present disclosure and the modified example thereof. Then, when extended software is removed from the controller, first, the advance processing program for removing a main program operating with reference to program information of another piece of extended software is executed, and then, the removal processing on the extended software is executed; and therefore, removal of the extended software can be properly performed, and a plurality of pieces of extended software can be collectively removed. Alternatively, for example, extended software is preconfigured to include an advance processing program for defining an order in which pieces of extended software are removed. Then, when extended software is removed from the controller, first, the advance processing program for defining an order in which pieces of extended software are removed is executed, and then, the removal processing on the pieces of extended software is executed in the order defined in the advance processing program. Consequently, removal of extended software based on an appropriate order can be properly performed, and a plurality of pieces of extended software can be collectively removed.

While the present disclosure has been described in detail, the present disclosure is not limited to each of the aforementioned embodiments and the modified examples thereof. Various additions, substitutions, changes, partial removals, and the like may be made to the embodiments and the modified examples thereof without departing from the spirit of the present disclosure or without departing from the scope of the present disclosure derived from the contents described in the claims and the equivalents thereof. Further, the embodiments and the modified examples thereof may be implemented in combination. For example, an operation order or a processing order is described as an example in the aforementioned embodiments and the modified examples thereof and is not limited thereto. Further, the above also holds when a numerical value or a mathematical expression is used in the description of the aforementioned embodiments and the modified examples thereof.

### Supplementary Notes

The following supplementary notes are further disclosed with regard to the aforementioned embodiments and the modified examples thereof.

### (Supplementary Note 1)

A controller 1 including:
an advance processing program storage unit 12 configured to store an advance processing program executed before change processing on extended software for controlling an extension function of a machine;
an advance processing program execution unit 13 configured to execute the advance processing program stored in the advance processing program storage unit 12; and
a change processing unit 14 configured to execute the change processing on the extended software after execution of the advance processing program by the advance processing program execution unit 13, wherein
the extended software is configured to include the advance processing program related to the extended software.

### (Supplementary Note 2)

The controller 1 according to Supplementary Note 1, further including:
an addition acceptance unit 16 configured to accept an addition command for selecting the extended software to be added from among one or more pieces of the extended software being addition candidates;
an advance processing program introduction unit 11 configured to, when the addition acceptance unit 16 accepts the addition command, read the advance processing program in the extended software to be added and store the program into the advance processing program storage unit 12, before the change processing being addition processing on the extended software is executed; and
an extended software storage unit 15 configured to store the added extended software 15, wherein,
when the addition acceptance unit 16 accepts the addition command, the change processing unit 14 executes processing of storing the extended software to be added into the extended software storage unit 15 as the addition processing, after the advance processing program execution unit 13 executes the advance processing program.

### (Supplementary Note 3)

The controller 1 according to Supplementary Note 2, wherein,
when the addition command accepted by the addition acceptance unit 16 indicates selection of a plurality of pieces of extended software to be added, the advance processing program introduction unit 11 reads all advance processing programs in the plurality of pieces of extended software to be added and stores the programs into the advance processing program storage unit 12,
the advance processing program execution unit 13 executes at least one of all the advance processing programs stored in the advance processing program storage unit 12, and
the change processing unit 14 executes the addition processing after the advance processing program execution unit 13 executes at least one of all the advance processing programs.

### (Supplementary Note 4)

The controller 1 according to Supplementary Note 2, further including
a candidate storage unit 10 configured to store the extended software being an addition candidate, wherein,
when the addition acceptance unit 16 accepts the addition command, the advance processing program introduction unit 11 reads an advance processing program related to the extended software to be added from the candidate storage unit 10 and stores the program into the advance processing program storage unit 12, before the addition processing is executed by the change processing unit 14.

### (Supplementary Note 5)

The controller 1 according to Supplementary Note 2, wherein
the extended software being an addition candidate is stored in a candidate storage unit 10 provided in an external storage device external to the controller 1, and,
when the addition acceptance unit 16 accepts the addition command, the advance processing program introduction unit 11 reads the advance processing program related to the extended software to be added from the candidate storage unit 10 and stores the program into the advance processing program storage unit 12, before addition processing is executed by the change processing unit 14.

### (Supplementary Note 6)

The controller 1 according to Supplementary Note 2, further including
a removal acceptance unit 17 configured to accept a removal command for selecting extended software to be removed from among one or more pieces of the extended software stored in the extended software storage unit 15, wherein,
when the removal acceptance unit 17 accepts the removal command, the advance processing program execution unit 13 executes an advance processing program related to the extended software to be removed out of the one or more advance processing programs stored in the advance processing program storage unit 12, before the change processing being removal processing on the extended software is executed, and
the change processing unit 14 executes processing of removing the extended software to be removed from the extended software storage unit 15 as the removal processing, after the advance processing program execution unit 13 executes the advance processing program.

### (Supplementary Note 7)

The controller 1 according to Supplementary Note 6, wherein,
when the removal command accepted by the removal acceptance unit 17 indicates selection of a plurality of pieces of extended software to be removed, the advance processing program execution unit 13 executes at least one of a plurality of advance processing programs related to the extended software to be removed out of the advance processing programs stored in the advance processing program storage unit 12, and
the change processing unit 14 executes the removal processing after the advance processing program execution unit 13 executes at least one of the plurality of advance processing programs.

### (Supplementary Note 8)

The controller 1 according to Supplementary Note 2, wherein
the advance processing program storage unit 12 and the extended software storage unit 15 are provided in a same storage device.

### (Supplementary Note 9)

The controller 1 according to any one of Supplementary Notes 1 to 8, wherein
the extended software is configured to include at least one advance processing program related to the extended software.

### (Supplementary Note 10)

The controller 1 according to Supplementary Note 9, wherein
the advance processing program storage unit 12 stores at least the one advance processing program.

### (Supplementary Note 11)

The controller 1 according to any one of Supplementary Notes 1 to 10, wherein
the controller 1 is a numerical controller controlling a machine tool being the machine.

### (Supplementary Note 12)

The controller 1 according to any one of Supplementary Notes 1 to 10, wherein
the controller 1 is a robot controller controlling a robot being the machine.

### REFERENCE SIGNS LIST

1 Controller
2 External storage device
10 Candidate storage unit
11 Advance processing program introduction unit
12 Advance processing program storage unit
13 Advance processing program execution unit
14 Change processing unit
15 Extended software storage unit
16 Addition acceptance unit
17 Removal acceptance unit
20 Control unit

1. A controller comprising:
an advance processing program storage unit configured to store an advance processing program executed before change processing on extended software for controlling an extension function of a machine;
an advance processing program execution unit configured to execute the advance processing program stored in the advance processing program storage unit; and
a change processing unit configured to execute the change processing on the extended software after execution of the advance processing program by the advance processing program execution unit, wherein
the extended software is configured to include the advance processing program related to the extended software.

2. The controller according to claim 1, further comprising:
an addition acceptance unit configured to accept an addition command for selecting extended software to be added from among one or more pieces of the extended software being addition candidates;
an advance processing program introduction unit configured to, when the addition acceptance unit accepts the addition command, read the advance processing program in the extended software to be added and store the program into the advance processing program storage unit, before the change processing being addition processing on the extended software is executed; and
an extended software storage unit configured to store the added extended software, wherein,
when the addition acceptance unit accepts the addition command, the change processing unit executes processing of storing the extended software to be added into the extended software storage unit as the addition processing, after the advance processing program execution unit executes the advance processing program related to the extended software to be added.

3. The controller according to claim 2, wherein,
when the addition command accepted by the addition acceptance unit indicates selection of a plurality of pieces of extended software to be added, the advance processing program introduction unit reads all advance processing programs in the plurality of pieces of extended software to be added and stores the programs into the advance processing program storage unit,
the advance processing program execution unit executes at least one of all the advance processing programs related to the plurality of pieces of extended software to be added stored in the advance processing program storage unit, and
the change processing unit executes the addition processing after the advance processing program execution unit executes at least one of all the advance processing programs.

4. The controller according to claim 2, further comprising
a candidate storage unit configured to store the extended software being an addition candidate, wherein,
when the addition acceptance unit accepts the addition command, the advance processing program introduction unit reads an advance processing program related to the extended software to be added from the candidate storage unit and stores the program into the advance processing program storage unit, before the addition processing is executed by the change processing unit.

5. The controller according to claim 2, wherein
the extended software being an addition candidate is stored in a candidate storage unit provided in an external storage device external to the controller, and,
when the addition acceptance unit accepts the addition command, the advance processing program introduction unit reads the advance processing program related to the extended software to be added from the candidate storage unit and stores the program into the advance processing program storage unit, before addition processing is executed by the change processing unit.

6. The controller according to claim 2, further comprising
a removal acceptance unit configured to accept a removal command for selecting extended software to be removed from among one or more pieces of the extended software stored in the extended software storage unit, wherein,
when the removal acceptance unit accepts the removal command, the advance processing program execution unit executes an advance processing program related to the extended software to be removed out of the one or more advance processing programs stored in the advance processing program storage unit, before the change processing being removal processing on the extended software is executed, and
the change processing unit executes processing of removing the extended software to be removed from the extended software storage unit as the removal processing, after the advance processing program execution unit executes the advance processing program.

7. The controller according to claim 6, wherein,
when the removal command accepted by the removal acceptance unit indicates selection of a plurality of pieces of extended software to be removed, the advance processing program execution unit executes at least one of a plurality of advance processing programs related to the extended software to be removed out of the advance processing programs stored in the advance processing program storage unit, and
the change processing unit executes the removal processing after the advance processing program execution unit executes at least one of the plurality of advance processing programs.

8. The controller according to claim 2, wherein
the advance processing program storage unit and the extended software storage unit are provided in a same storage device.

9. The controller according to claim 1, wherein
the extended software is configured to include at least one advance processing program related to the extended software.

10. The controller according to claim 9, wherein
the advance processing program storage unit stores at least the one advance processing program.

11. The controller according to claim 1, wherein
the controller is a numerical controller controlling a machine tool being the machine.

12. The controller according to claim 1, wherein
the controller is a robot controller controlling a robot being the machine.
